(19) United States
(12) Patent Application Publication
(10) Pub. No.: US 2009/0300068 A1
(43) Pub. Date: Dec. 3, 2009

(54) SYSTEM AND METHOD FOR PROCESSING STRUCTURED DOCUMENTS

(76) Inventor: Ding-Yuan Tang, Pleasanton, CA (US)

Correspondence Address: HAHN AND MOODLEY, LLP, 548 Market Street, San Francisco, CA, 94104, US

(21) Appl. No.: 12/476,146

(22) Filed: Jun. 1, 2009

Related U.S. Application Data
(60) Provisional application No. 61/057,659, filed on May 30, 2008.

(51) Int. Cl. G06F 17/30; G06K 9/72; G10L 15/00

(52) U.S. Cl. 707/104.1; 382/229; 704/246; 704/E15.001; 707/E17.101

(57) ABSTRACT

Embodiments of the invention disclose a capture device, and a portal service for the processing of structured documents in the form of the receipts, and business cards. In one embodiment, the capture device such as a camera-enabled mobile phone passes images of proof of expense (receipts) to the portal service via an intermediate network. The portal service recognizes and classifies the image content into a central repository for later access by an individual or company.

This application claims the benefit of priority to U.S. No. 61/057,659, filed May 30, 2008, the specification of which is hereby incorporated by reference.

### FIELD

Embodiments of the present invention relate to the processing of structured documents such as receipts, and expense reports.

### BACKGROUND

Expense reports are commonly submitted by employees wishing to be reimbursed for the expenses incurred on a company's behalf. For every item on the expense report, it may be mandatory for the employee to also submit a proof of the expense typically in the forms of receipt or invoice.

Naturally, an expense report should contain only accurate information so that these expenditures can be properly entered into a company's financial statement.

Business cards are frequently exchanged at business meetings. It is desirable to have the contact information printed on a business card input into a contact management system.

### SUMMARY

Embodiments of the invention disclose a capture device, and a portal service for the processing of structured documents in the form of the receipts, and business cards.

In one embodiment, the capture device e.g. a camera-enabled mobile phone passes images of proof of expense (receipts) to a portal service via an intermediate network. The portal service recognizes and classifies the image content into a central repository for later access by an individual or company.

Other aspects of the invention will be apparent from the detailed description below.

### BRIEF DESCRIPTION OF THE DRAWINGS

FIG. 1 shows a high-level functional block diagram of a capture device, and a portal service, in accordance with one embodiment of the invention.

FIG. 2 shows a flowchart of operations performed in order to extract data from a structured document, in accordance with one embodiment of the invention.

FIG. 3 is a schematic drawing illustrating the operation of the portal service of the present invention, in accordance with one embodiment.

FIG. 4 shows a high-level block diagram of hardware that may be used to implement the portal service, in accordance with one embodiment of the invention.

### WRITTEN DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Embodiments of the present invention disclose techniques to process structured business documents in the form of receipts, and business cards.

In order to describe the present invention, a receipt will be used as an example of a structured document, however it should be borne in mind that the techniques and systems disclosed herein may equally be used in respect of the processing of business cards.

In one embodiment, the processing of a receipt may be part of an overall business expense reporting process.

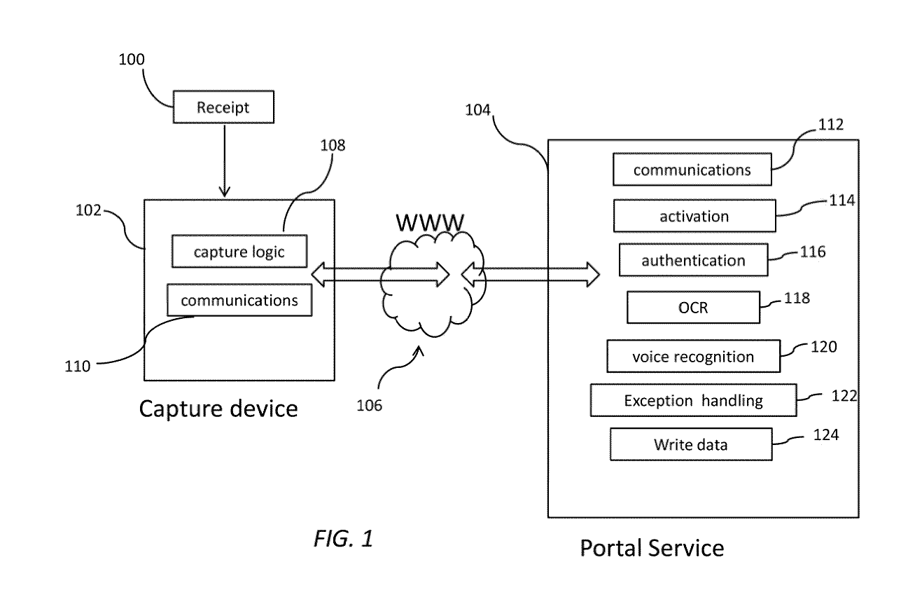

FIG. 1 of the drawings shows an overview of such a business expense reporting process, in accordance with one embodiment of the invention. Referring to FIG. 1, a receipt 100 pertaining to a business transaction such as, for example, a business lunch needs to be reported. A user captures an image of the receipt using a capture device 102. The capture device 102 may be any device equipped with a digital camera to capture an image of a receipt. Examples of capture devices include mobile phones and notebooks equipped with a camera.

The capture device 102 passes images of proof of expense (receipts) to a portal service 104 via an intermediate network 106, which in accordance with embodiments of the invention may be a wide area network (WAN) such as the World Wide Web or the Internet. The portal service 104 recognizes and classifies the image content into a central repository for later access by an individual or company.

To start, a user installs capture application/logic 108 on the capture device 102. Next, the user performs an activation operation to activate the capture application for use with a data extraction service provided by the portal 104. During activation of the application, an activation server of the portal 104 will issue an unique ID to identify the user/device later on. As part of the activation operation the user typically provides access information to access the data extraction service. Such access information includes the user's login information for the data extraction service

During runtime of the application, a user enters into a one-click process to initiate the capture of a receipt. Upon initialization, the capture application 108 will bring up a user interface instructing the user to take a snapshot of the proof of purchase. The snapshot is then sent to the portal 104 over the network 106 using a communications processing block 112. In one embodiment, at this time, the user can add voice dictation as a memo explaining the use or provide additional details for the expense.

The captured image of the receipt along with the voice memo is be routed as described to the web server of the portal 104. Since each device contains the unique ID issued during the activation process, the server can automatically identify the source of the data.

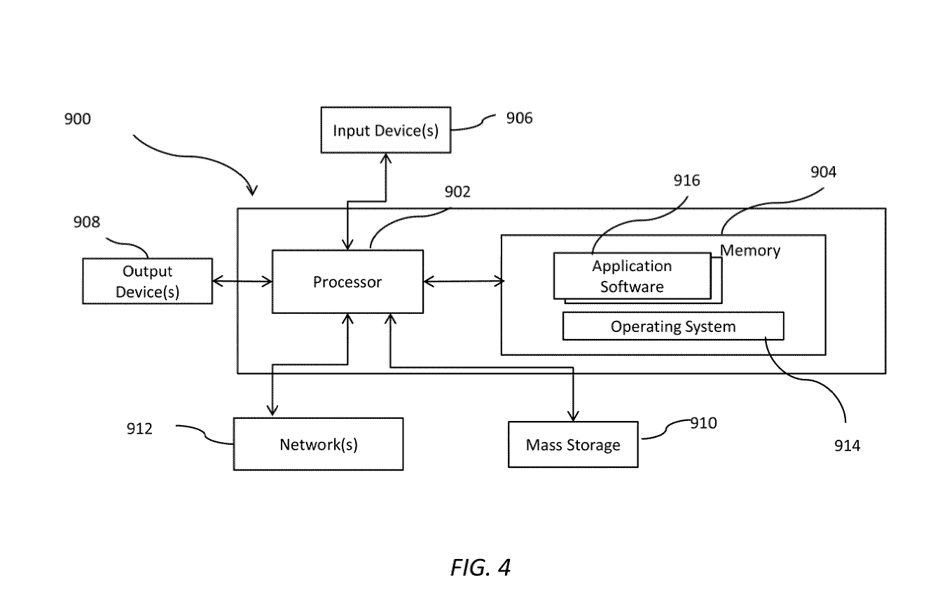

The portal service 104 may be architected using one or more servers, as one of ordinary skill in the art would appreciate. FIG. 4 of the drawings shows representative hardware for implementing the portal service 104, in accordance with one embodiment of the invention. Regardless of the particular hardware used to implement the portal service, said portal service is required to implement the functional blocks shown in block diagram of FIG. 1.

These functional blocks include a communications block 112, an activation block 114, and authentication block 116, an OCR block 118, a voice-recognition block 120, an exception/error handling block 122, and of write data block 124. The functions performed by each of these blocks will be apparent from the description below

The communications block 112 is responsible for receiving data transmissions and the capture device 102. The activation block 114 is responsible for performing the above-described activation operations

The authentication block 116 is responsible for authenticating any communication from a capture device 102. As such, identification block 116 executes an authentication process which uses the unique ID assigned to the capture device 102, as well as the user's login information to authenticate a particular combination of capture device and user. Only authenticated transmissions are subjected to a data extraction process. The data extraction process includes passing the image of the receipt to the OCR block 118 to extract the data from the receipt. Said data may include information such as transaction date, time, place, etc., as well as each line item describing a particular charge. To extract the data, the OCR block 118 includes OCR/ISR algorithms.

In one embodiment, OCR block 118 may categorize transactions on a receipt automatically. Examples of categories include transportation, entertainment, meals, etc.

If that transmission contains a voice memo, the voice memo will be captured using voice recognition technology and converted to ASCII text and associated as a text memo with-the transaction data extracted from the receipt image.

In one embodiment, if the portal service/system has difficulty converting either the image or voice submitted by the user or the converted result is below a certain confidence percentage, it will go through an additional verification process by a live operator as a means to either verify or correct the machine recognition result. Thus, exception handling block 122 includes logic to the image data, voice data, and in the extracted data for checking the invoice data to a live operator. Text for which a portal service has difficulty recognizing will be referred to herein as “suspect text”, whereas voice data for which the portal service has difficulty recognizing will be referred to herein as “suspect voice”.

The resultant/extracted data is entered and stored into a database by the write data block 124. Set expected data indexed by user and/or the company. Because each transaction is captured and indexed by using the captured data, the portal/system is able to generate an electronic file which can be sorted and queried.

The result can be accessed by the accounting department or the responsible individual from the account can either via a web portal or download the data including the original image as an electronic file. If the user's company uses any third party software or web portal application for accounting, the system also offers functionality to sync directly with the third-party system.

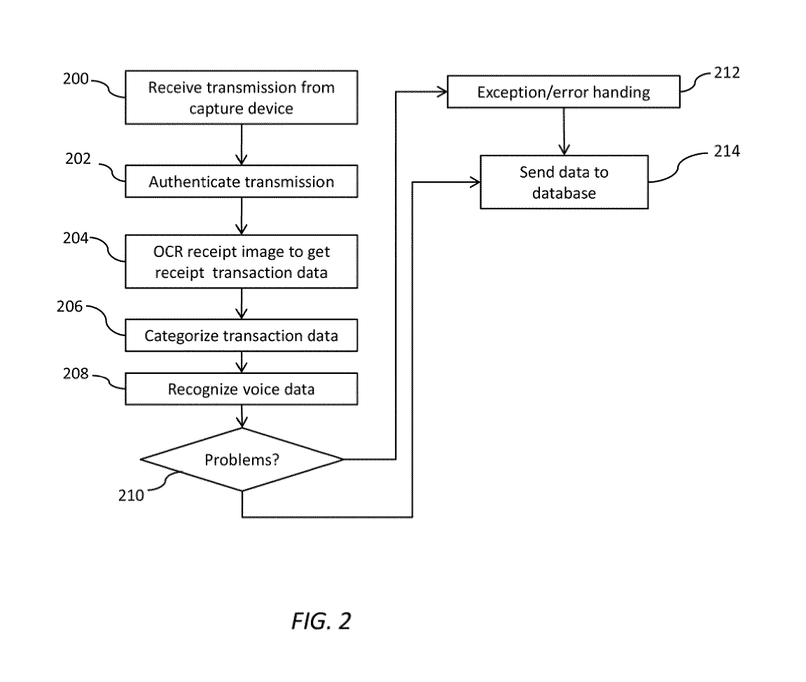

The above-described data extraction process performed by the portal 104 may be represented by the flowchart of FIG. 2. Referring to FIG. 2, at block 200, the portal 104 receives a transmission from the capture device 102, as described at block 202 the portal authenticates the transmission. At block 204 optical character recognition is performed on a receipt image contained in the transmission in order to extract transaction data. At block 206, the transaction is categorized. If the transmission also contains voice data, then at block 208, the voice data is recognized and associated as a text memo with the extracted transaction data. If there are problems associated with the recognition of either the receipt image, or the voice data then exception/error handling block 212 executes wherein the data is routed to a live operator for verification and/or correction. At block 214, the extracted data is sent to the database. Advantageously, the database is hosted on the Internet, and can be accessed by a user and/of said user's company.

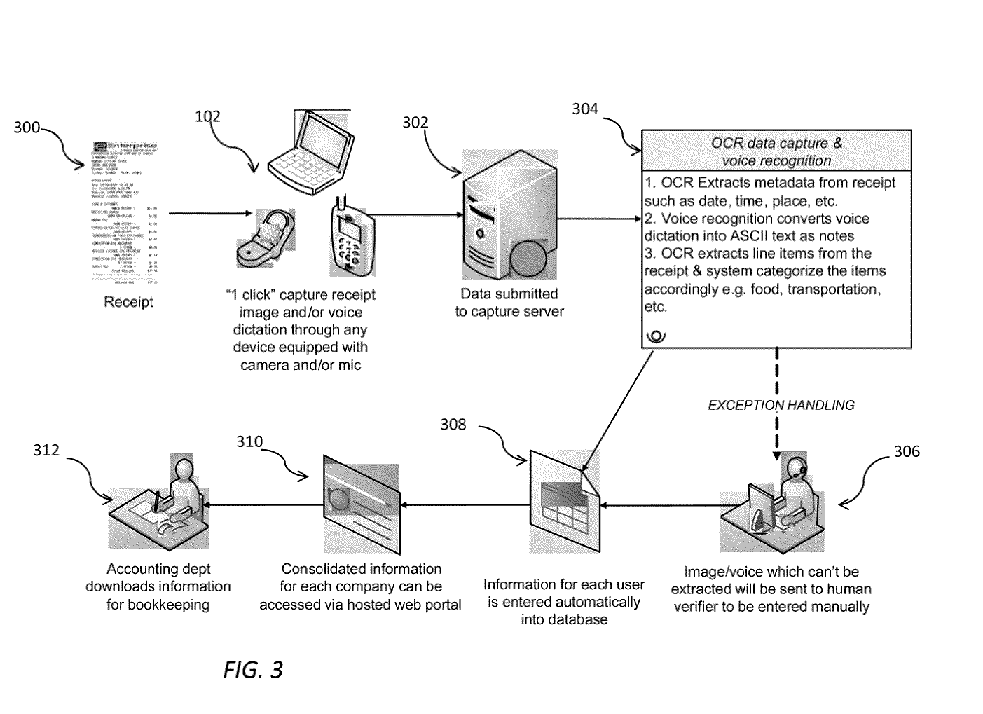

FIG. 3 is a schematic drawing showing the portal service 104, in use, in accordance with one embodiment. Referring to FIG. 3, a receipt 300 is captured as a receipt image via a capture device 102. The receipt image is transmitted over the Internet to a server 302 of the portal service 106. The portal service 106 executes processing blocks 304 to extract transaction data, as described above. Errors in the extraction process are routed through an exception handling process to a live operator 306. Extracted and verified data is automatically entered into database 308. The database 308 is exposed to users as a hosted web portal 310 which is accessible to the accounting departments 312.

In addition to expense report processing, the techniques of the present invention may be gainfully applied with respect to the processing of business cards. Here, business cards may be scanned by a capture device and transmitted over a network to the portal service 106 for data extraction using the techniques described above. The extracted data may be written or entered directly into a contact manager, customer relationship manager, e-mail client, etc.

FIG. 4 of the drawings shows an example of hardware 400 that may be used to implement the portal service 106, in accordance with one embodiment of the invention. The hardware 400 typically includes at least one processor 402 coupled to a memory 404. The processor 402 may represent one or more processors (e.g., microprocessors), and the memory 404 may represent random access memory (RAM) devices comprising a main storage of the hardware 400, as well as any supplemental levels of memory e.g., cache memories, non-volatile or back-up memories (e.g. programmable or flash memories), read-only memories, etc. In addition, the memory 404 may be considered to include memory storage physically located elsewhere in the hardware 400, e.g. any cache memory in the processor 402, as well as any storage capacity used as a virtual memory, e.g., as stored on a mass storage device 410.

The hardware 400 also typically receives a number of inputs and outputs for communicating information externally. For interface with a user or operator, the hardware 400 may include one or more user input devices 406 (e.g., a keyboard, a mouse, a scanner etc.) and a display 408 (e.g., a Liquid Crystal Display (LCD) panel). For additional storage, the hardware 400 may also include one or more mass storage devices 410, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 400 may include an interface with one or more networks 412 (e.g., a local area network (LAN), a wide area network (WAN), a wireless network, and/or the Internet among others) to permit the communication of information with other computers coupled to the networks. It should be appreciated that the hardware 400 typically includes suitable analog and/or digital interfaces between the processor 402 and each of the components 404, 406, 408 and 412 as is well known in the art.

The hardware 400 operates under the control of an operating system 414, and executes various computer software applications, components, programs, objects, modules, etc. indicated collectively by reference numeral 416 to perform the techniques described above

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

1. A method, comprising:
performing an activation operation on a capture device to activate a capture application, the capture application to capture an image of a structured document, to capture user input voice data relating to the structured document, and to transmit the image of the structured document and the user input voice data to a server; and
initiating a capture operation with said capture application.

2. The method of claim 1, wherein performing said activation operation comprises providing access information to access a data extraction service to extract data from the structured document.

3. The method, comprising:
receiving a transmission from a capture device;
authenticating the transmission;
performing an optical character recognition (OCR) operation to extract data from a document image in the transmission; and
storing the extracted data in a database.

4. The method of claim 3, further comprising performing a voice-recognition operation to convert voice data in the transmission to text.

5. The method of claim 4, wherein said storing comprises storing the converted voice data in said database.

6. The method of claim 3, further comprising routing the document image and the extracted data to a live operator to verify the extracted data.

7. The method of claim 6, wherein said routing is performed only in the case of suspect text.

8. The method of claim 4, further comprising routing the voice data and its associated converted text to a live operator for verification.

9. The method of claim 8, wherein said routing of the voice data and its associated converted text is performed only in the case of suspect voice.

10. The method of claim 3, wherein said database is hosted on the World Wide Web.

11. The method of claim 3, wherein said document image is selected from the group consisting of a receipt, and a business card.

12. The method of claim 11, wherein in the case of the document image being of a receipt, categorizing the receipt into an expense category based on the extracted data for the receipt.

13. The method of claim 11, wherein in the case of the document image being of a business card, generating contact information for the business card based on the extracted data.

14. A system, comprising:
processor; and
memory coupled to the processor, the memory storing instructions which when executed by the processor, cause the system to perform a method, comprising:
receiving a transmission from a capture device; authenticating the transmission;
performing an optical character recognition (OCR) operation to extract data from a document image in the transmission; and
storing the extracted data in a database.

15. The system of claim 14, further comprising performing a voice-recognition operation to convert voice data in the transmission to text.

16. The system of claim 14, wherein said storing comprises storing the converted voice data in said database.

17. A computer-readable medium having stored thereon a sequence of instructions which when executed by a system, cause the system to perform a method comprising:
receiving a transmission from a capture device;
authenticating the transmission;
performing an optical character recognition (OCR) operation to extract data from a document image in the transmission; and
storing the extracted data in a database.

18. The computer-readable medium of claim 17, further comprising performing a voice-recognition operation to convert voice data in the transmission to text.

19. The computer-readable medium of claim 17, wherein in the case of the document image being of a receipt, categorizing the receipt into an expense category based on the extracted data for the receipt.

20. The computer-readable medium of claim 17, wherein in the case of the document image being of a business card, generating contact information for the business card based on the extracted data.
